(19) United States
(12) Patent Application Publication
(10) Pub. No.: US 2013/0166470 A1
(43) Pub. Date: Jun. 27, 2013

(54) METHOD AND SYSTEM FOR COMPARING COST OF SHIPPING OPTIONS

(71) Applicants: Darius Grala, Westborough, MA (US); Jamey M. Blakely, Shrewsbury, MA (US); Rick Botti, Palo Alto, CA (US); Richard Perry, Palo Alto, CA (US)

(72) Inventors: Darius Grala, Westborough, MA (US); Jamey M. Blakely, Shrewsbury, MA (US); Rick Botti, Palo Alto, CA (US); Richard Perry, Palo Alto, CA (US)

(73) Assignee: PSI SYSTEMS, INC., Palo Alto, CA (US)

(21) Appl. No.: 13/643,246

(22) PCT Filed: Apr. 25, 2011
(86) PCT No.: PCT/US11/33765

§ 371 Date: Mar. 5, 2013

Related U.S. Application Data
(60) Provisional application No. 61/328,059, filed on Apr. 26, 2010.

(51) Int. Cl. G06Q 10/08

(52) U.S. Cl. CPC G06Q 10/08345
USPC 705/335

(57) ABSTRACT

A method and system for comparing cost of shipping options are provided. The method includes determining, with a computer system, based on shipping data input into the computer system, a first shipping cost for shipping the package using a first mail carrier; determining, with the computer system, based on the shipping data, a second shipping cost for shipping the package using a second mail carrier; calculating, with the computer system, a cost difference between the first shipping cost and the second shipping cost; outputting by the computer system the cost difference; and periodically sending the cost difference for shipping the package or a plurality of packages to an individual or organization monitoring shipping costs.

### BACKGROUND OF THE INVENTION

1. Field of the Invention

The present invention pertains to shipping and mailing and in particular to a method and system for comparing cost of shipping options.

2. Discussion of Related Art

The use of centralized mailing facilities have achieved wide acceptance. Various organizations such as corporations, firms, banking institutions, government institutions, and small businesses, and individuals utilize these centralized mailing facilities to mail or ship various types of mailings including letters, packages or parcels.

Generally, these centralized mailing facilities employ mailing clerks for preparing the mail (e.g. weighing the mail, labeling the mail, etc.) and entering data (e.g., weight, dimensions, origin, destination, parcel value, timing, pickup options, delivery, delivery notification, etc.) into a mailing database for printing a proper mailing label for mailing or shipping a package via a mail carrier. For example, within the United States of America (USA), there are many mail carriers such as United States Postal Service (USPS), United Parcel Service (UPS™), Federal Express (FedEx®) and DHL Express. A selection of a particular mail carrier often depends on an individual manager of the centralized mailing facility. The individual manager of the carrier facility often selects a particular mail carrier based on a negotiated mailing agreement for discounted shipping rates. However, this may not be the best strategy in a competitive world where there are various shipping options offered for shipping or mailing a package or letter.

Some shipping managers appreciate the fact that there is the possibility to comparison shop between various rates offered by various carriers. However, effective comparison shopping across multiple carriers can be difficult and a time-consuming task. Many centralized mail facilities of organizations rely on one or two carrier rather than comparison shopping for the best shipping rate across multiple carriers.

Therefore, there is a need for a method a system for comparing cost of shipping options between multiple mail carriers.

### BRIEF SUMMARY OF THE INVENTION

An aspect of the present invention is to provide a method for comparing cost of shipping options. The method includes determining, with a computer system, based on shipping data input into the computer system, a first shipping cost for shipping the package using a first mail carrier; determining, with the computer system, based on the shipping data, a second shipping cost for shipping the package using a second mail carrier; calculating, with the computer system, a cost difference between the first shipping cost and the second shipping cost; outputting by the computer system the cost difference; and periodically sending the cost difference for shipping the package or a plurality of packages to an individual or organization monitoring shipping costs.

Another aspect of the present invention is to provide a system for comparing cost of shipping options, the system comprising a processor configured to: (a) determine, based on shipping data input by a user, a first shipping cost for shipping a package using a first mail carrier; (b) determine, based on the shipping data input by the user, a second shipping cost for shipping the package using a second mail carrier; (c) calculate a cost difference between the first shipping cost and the second shipping cost; (d) output the cost difference; and (e) send the cost difference for shipping to package or a plurality of packages to an individual or organization monitoring shipping costs.

Although the various steps of the method of providing or printing postage stamps are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is a flow chart of a method for determining and comparing costs of shipping options, according to an embodiment of the present invention;

FIG. 2 depicts a graphical interface of an example of a first software application for processing shipments;

FIG. 3 depicts a graphical user interface of an example of a software application according to an embodiment of the present invention for comparing costs of shipping and processing shipments;

FIG. 4 shows menu in the graphical user interface shown in FIG. 3, according to an embodiment of the present invention;

FIG. 5 depicts a “Savings Log” window obtained by activating a savings log button in the graphical interface shown in FIG. 3, according to an embodiment of the present invention; and

FIG. 6 shows an example of an email that is received by a shipping manager that is responsible for tracking shipping expenses within an organization; in accordance with an embodiment of the present invention.

### DETAILED DESCRIPTION OF EMBODIMENTS OF THE INVENTION

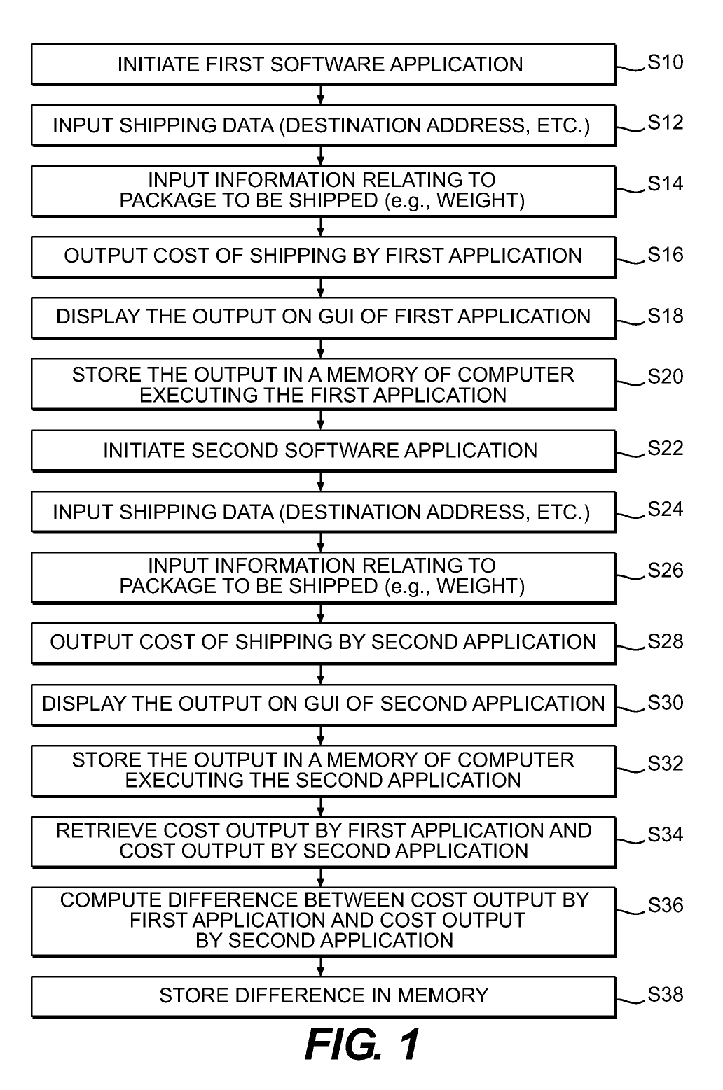

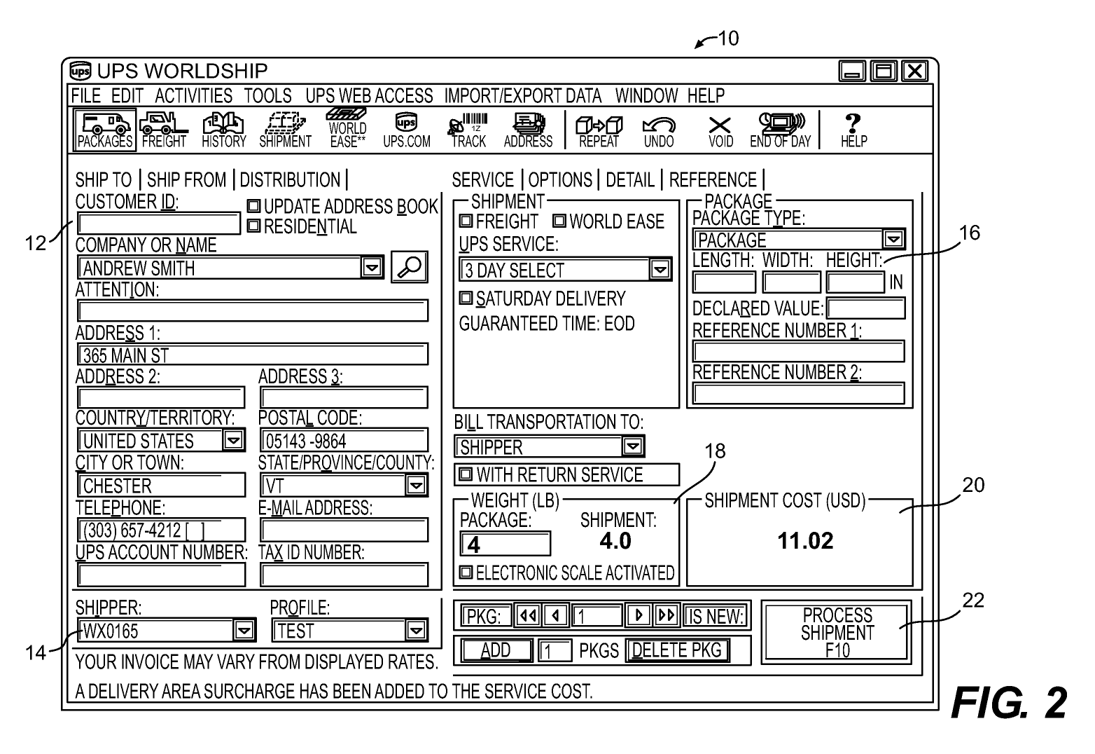

FIG. 1 is a flow chart of a method for determining and comparing costs of shipping options, according to an embodiment of the present invention. The method includes initiating a first software application (e.. a conventional software application) for processing shipments by a user at a computer terminal, at S10. The method further includes displaying a graphical user interface on a computer of a user (e.g., a clerk at a shipping warehouse). FIG. 2 depicts a graphical interface 10 of an example of a first software application for processing shipments through a first mail carrier. In this example, the software application is UPS WORLDSHIP™ of United Parcel Service. The UPS WORLDSHIP™ software application is used to send shipment through UPS™ as the first mail carrier. Although, the method is described herein with reference to UPS™ as the first mail carrier, any other mail carrier can be used by launching the software application of that mail carrier. For example, when using FedEx as a possible mail carrier, FedEx SHIP MANAGER can be used instead.

The method further includes inputting by the user (e.g., the clerk at the shipping warehouse) of various shipping data including inputting the name of the individual or the organization, destination address, destination postal code, telephone number, and any other information data as may be needed at window 12 of graphical user interface 10, at S12. The shipping data may further include a shipper code that is input at window 14 of the graphical user interface 10. The shipper code is a series of letters and/or digits assigned to the shipper (e.g., the individual or organization that is shipping or mailing the letter or package). The method further includes inputting information data relating to the package being shipped such the type of service at window 14, the type of package and dimensions of the package at window 16, the weight of the package, at window 18, at any other data such as declared value, reference number, etc., at S14.

The method further includes outputting a shipment cost based upon the input data in the graphical interface 10, at S16. Specifically, using the data input by the user, the software application accesses a rate table and outputs the shipment cost for shipping the package. The method further includes displaying the output shipment cost for shipping the package to the specified destination in window 20 of the graphical interface 10, at S18. The method may further include storing the output cost in a memory of a computer executing the software application, at S20.

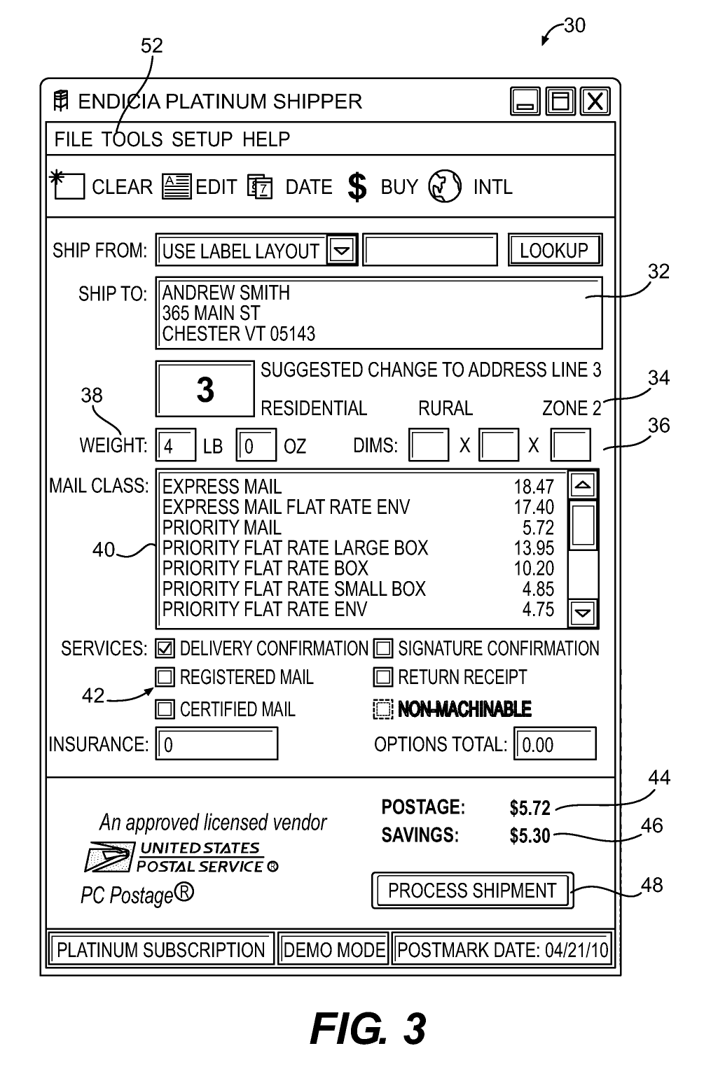

The method further includes initiating a second software application for comparing cost of shipping options and for processing shipments through a second mail carrier, according to an embodiment of the present invention, at S22. In one embodiment, the initiating includes the user manually clicking to open the second software application. In another embodiment, the initiating of the second software application is performed automatically once the user manually initiates the first software application, for example, substantially simultaneously. The method includes displaying a graphical user interface on a computer of a user (e.g., a clerk at a shipping warehouse). FIG. 3 depicts a graphical user interface 30 of an example of a second software application according to an embodiment of the present invention for comparing costs of shipping and processing shipments. In this example, the second software application is ENDICIA PLATINUM SHIPPER™ of Endicia. In one embodiment, USPS is used as the second mail carrier for delivering the shipments processed using when using the second application software (e.g., the ENDICIA PLATINUM SHIPPER). In one embodiment, the method further includes inputting by the user (e.g., the clerk at the shipping warehouse) of various shipping data including inputting the name of the individual or the organization, destination address, destination postal code, telephone number, and any other information data as may be needed at window 32 of graphical user interface 30, at S24. In another embodiment, the method includes automatically importing the shipping data input by the user into the graphical interface 10 from the graphical user interface 10 into the graphical user interface 50.

The method further includes inputting information data relating to the package being shipped, at S26, such as the type of service at window 34, the type of package and dimensions of the package at window 36, the weight of the package, at window 38. The method further includes inputting the type of mailing or shipping service requested by the user for shipping the package, at window 40. In one embodiment, the type of service includes the various mail services provided by USPS including Express Mail, Express Mail Flat Rate Envelope, Priority Mail, Priority Flat Rate Large Box, Priority Flat Rate Box, Priority Rate Small Box, Priority Flat and Rate Envelope. The mail services may also include requesting a delivery confirmation, a registered mail, a certified mail, a signature confirmation or a return receipt, or any combination of two or more thereof when available by selecting any of the boxes 42. The method further includes outputting by the second software application a shipment cost based upon the input data, at S28. In one embodiment, the method includes displaying the output shipment cost on window 44 of the graphical interface 30, at S30. Using the data input by the user, the second software application accesses a rate table provided by USPS and outputs (and displays) the shipment cost for shipping the package to the specified destination in window 44 of the graphical interface 30. The method may further include storing the output cost in a memory of a computer executing the second software application, at S32.

The method further includes retrieving the shipment cost output by the first software application and the shipment cost output by the second application, at S34. The method further includes computing the difference between the output shipment cost obtained using the first software application (e.g., UPS WORLDSHIP or FedEx SHIP MANAGER) and the output shipment cost obtained using the second software application (e.g., ENDICIA PLATINUM SHIPPER), at S36. In one embodiment, the calculated or computed difference is displayed as “Savings” at 46 in graphical user interface 30. In one embodiment, the calculated or computed difference is labeled “savings” as the cost obtained using the second software application is less than the cost obtained using the first software application. In other words, the user would save in cost of shipping when using the USPS carrier instead of the UPS or FedEx carriers. In one embodiment, the method further includes storing the calculated or computed difference in a memory of the computer executing the second software application, at S38.

In one embodiment, the method further includes storing in a memory of the computer the computed difference as “actual savings” when the user uses the USPS as the first mail carrier for shipping the package, i.e., when the user activates button “Process Shipment” 48 in graphical user interface 30 of the second software application. The difference is referred to herein as “Actual Savings” as the user actually saves in shipping costs. The method further includes storing in a memory of the computer the computed difference as “Potential Savings” when the user uses the first mail carrier (e.g., UPS or FEDEX) other than the second mail carrier (USPS) for shipping the package, i.e., when the user activates button “Process Shipment” 22 in graphical user interface 10 of the first software application. The difference is referred to as “Potential Savings” as the user did not save in shipping charges when shipping the package but this value corresponds to potential savings if the user would have selected to use the USPS mail carrier by clicking on button “Process Shipment” 48 in graphical user interface 30 instead of activating button process shipment 22 in graphical user interface 10.

For each shipment processed by the user, a difference is automatically stored either as “actual savings” or as “potential savings” depending on whether the user actually saved in shipping costs in the case of actual savings when the shipment is processed through the second mail carrier (USPS) or would have saved in shipping costs in the case of potential savings in the case where the user selected the first mail carrier (UPS) instead of the second mail carrier (USPS) even though the shipping costs are less when using USPS instead of the competitor mail carrier (e.g., UPS or FEDEX).

In one embodiment, data including the cost difference on shipments where actual savings is realized are stored in a first file, referred to herein as “Actual Log” in a memory of the computer executing the second software application (e.g., ENDICIA PLATINUM SHIPPER). Data including the cost difference on shipments where potential savings are shown are stored in a second file, referred to herein as “Potential Log” in a memory of the computer executing the second software application.

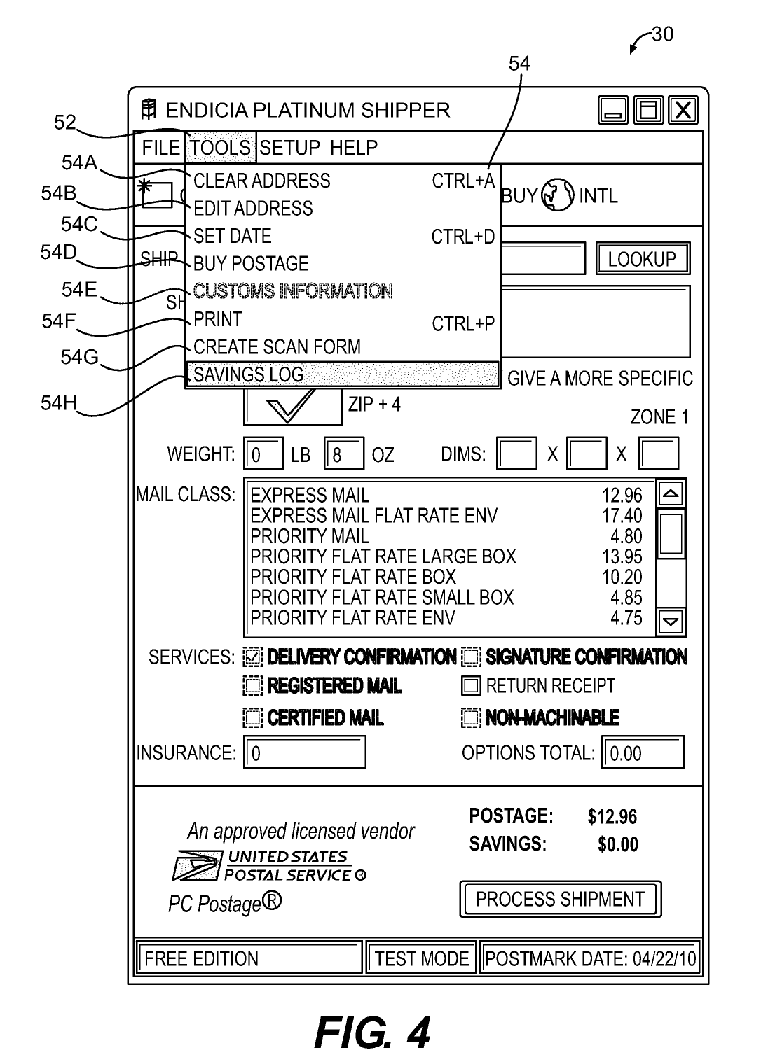

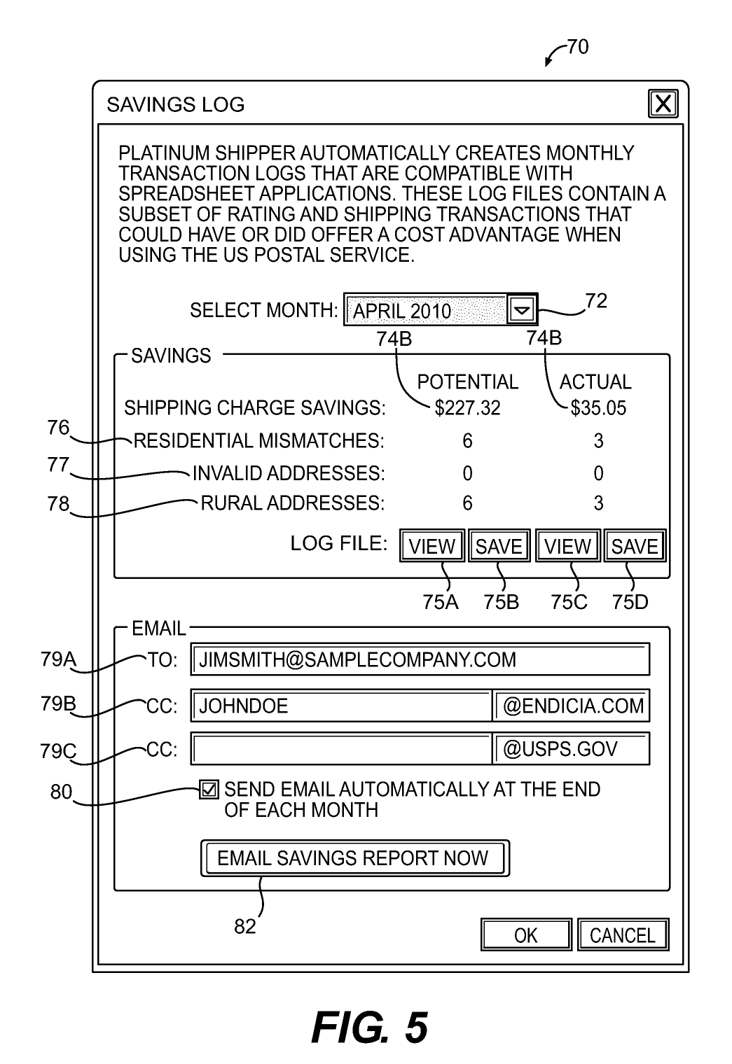

When a user clicks on tools at 52 in the graphical user interface 30, a menu 54 is displayed. FIG. 4 shows the menu 54 in the graphical user interface 30, according to an embodiment of the present invention. The menu 54 contains various action lines including “Clear Address” 54A for deleting a destination address that has been entered, “Edit Address” 54B for changing or editing the destination address that has been entered, “Set Date” 54C to set a date for shipping, “Buy Postage” 54D to purchase postage for shipping, “Customs Information” 54E to input data for customs processing if the shipping is international, “Print” 54F to print postage labels, “Create SCAN Form” 54G, and “Savings Log” 54H to create a report showing “Actual Savings” on shipping that have been realized and “Potential Savings” that would have been realized if USPS has been selected as the mail carrier. By clicking on action line “Savings Log” 64H, a “Savings Log” window 70 pops up. FIG. 5 depicts the “Savings Log” window 70, according to an embodiment of the present invention. The window 70 display the following text “Platinum Shipper automatically creates monthly transaction logs that are compatible with spreadsheet applications. These log files contain a subset of rating and shipping transactions that could have or did offer a cost advantage when using US Postal Service.” The window 70 includes a scroll window 72 for selecting a period such as, for example, April 2010, March 2010, etc., for which to run a sum on savings log, i.e., perform a summation of potential savings as well as the actual savings realized during the selected period. For example, as shown in FIG. 5, a savings log summation is run for the month of April 2010. Although, the savings logs summation shown run for a period of one month, any period can be selected, for example, one day, two or more days, one weekly, two or more weeks, one month, two or more months, one year, etc. Once the period (e.g., April 2010) is selected, the software application automatically computes the sum of potential savings and the sum of actual savings in the window 70. For example, as shown in FIG. 5, the sum of actual savings for the month of April 2010 is shown at 74A as being $35.05 while the sum of potential savings for the same month is shown at 76B as being $227.32. Therefore, during the month of April 2010, the user saved $35.05 in total costs of shipping by using USPS and would have saved $227.32 for that same period if the user has selected USPS as the mail carrier. This tool allows the user or the shipping manager to monitor shipping costs and to compare shipping costs between various options of shipping. The potential savings indicates the amount that the user could have saved if the shipment was processed using the second software application which linked to the USPS as the mail carrier. The potential savings will thus entice the user to select to process the shipment with the second software application and thus use USPS as the mail carrier.

In addition, on the widow 70 are reported the number of residential mismatches 76, the number of invalid addresses 77, and the number of rural addresses 78. The number of residential mismatches reports the number of residential addresses where the user failed to indicate that the destination addresses are residential. As a result, the sender or user can incur an additional fee or charge from the first mail carrier (e.g., UPS or FedEx). Similarly, the number of rural addresses reports the number of residential addresses in rural areas where the user failed to indicate that the destination addresses are rural. As a result, the sender or user can incur an additional fee or charge from the mail carrier (e.g., UPS or FedEx). Similarly, the sender or user can also incur additional fees or charges from the mail carrier (e.g., UPS or FedEx) if the destination address is invalid or not correct. Therefore, in addition to the potential saving that the user failed to capture by the user's failure to select the USPS as the mail carrier, the user further incurred additional costs or fee due to the fact that the user did not indicate in the software application that the destination address is a residential address or a rural address.

The window 70 includes button “view” 75A and button “save” 75B. A user can click on button view 75A to view the potential savings log file. The user can also click on button save 75B to store the potential savings log. The window 70 also includes button “view” 75C and button “save” 75D. A user can click on button view 75C to view the actual savings log file. The user can also click on button save 75D to store the actual savings log. In one embodiment, the potential and actual savings log files are Microsoft EXCEL files. However, as it can be appreciated, the potential savings log file and/or the actual savings log file can be any type of file containing the specifics of the various shipments along with the potential or actual savings associated with each shipment.

The window 70 also includes areas reserved for inputting email addresses. In one embodiment, there are provided three areas 79A, 79B and 79C for specifying email addresses where to send the savings report, i.e., where to send the two files “potential log” and “actual log” described in the above paragraphs. For example, as shown in FIG. 5, the “to:” line in the area 79A can be populated with the email address of the shipping manager that is responsible of tracking shipping expenses within an organization (e.g., jimsmith@samplecompany.com). The “cc:” line in the area 79B can be populated with the email address of the individual at the company that installed the second software application (e.g. Endicia) (e.g., johndoe@endicia.com). The “cc:” line in the area 79C can be populated with the email address of an individual at the USPS (e.g., someone@usps.gov).

The window 70 may further include a button 80 for specifying that the savings report including the potential savings log file and the actual savings log file be sent automatically at the end of each month. Although, in this example, the period is set at one month, as it can be appreciated, the period can be customized as desired. For example, emailing the savings report can be implemented at the end of each business day, or at the end of each week, every two weeks, every month, every two months, etc.

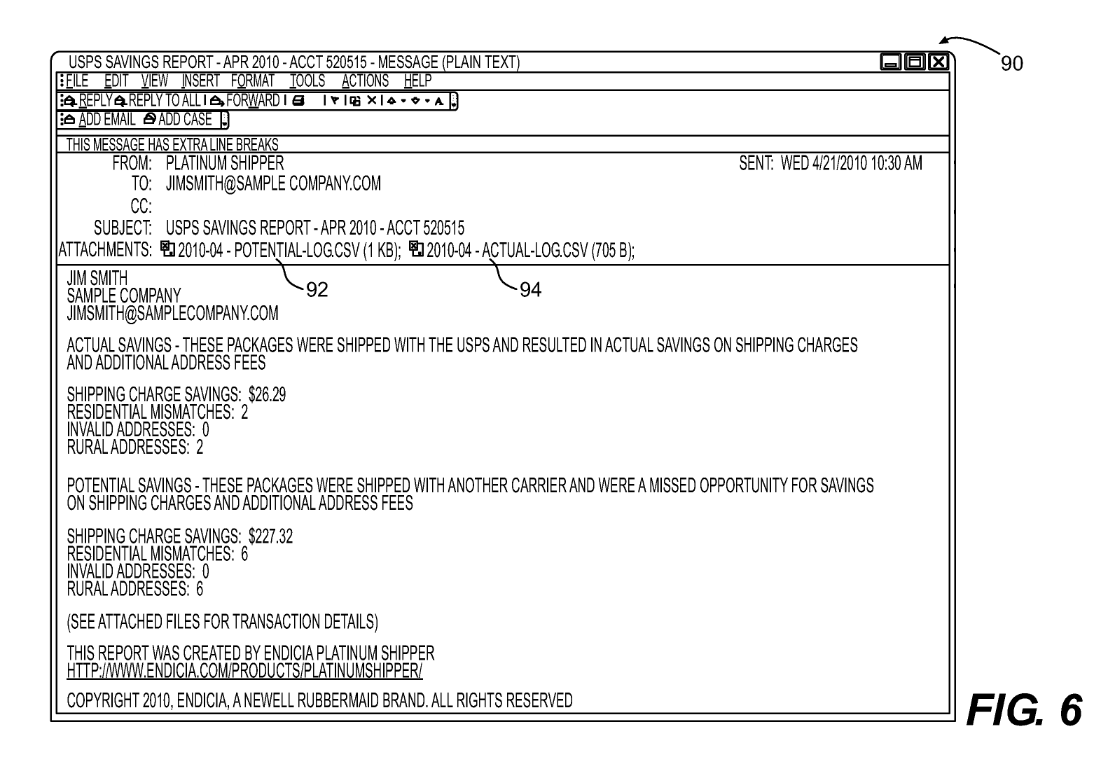

FIG. 6 shows an example of an email 90 that is received by, for example, the shipping manager that is responsible for tracking shipping expenses within an organization (e.g., jimsmith@samplecompany.com). The email 90 contains two file attachments 92 and 94 which are the potential savings log file and the actual saving log file, respectively. In the body of the email are summarized the actual savings (e.g., $26.29) and the potential savings (e.g.,$227.32). The actual savings correspond to packages which are shipped with the USPS and resulted in actual savings on shipping charges and additional address fees. The potential savings correspond to packages which are shipped with another mail carrier other than USPS and thus are missed the opportunity for saving on shipping charges and additional address fees. At the end of the email 90, the receiver of the email is invited to explore the attached files 92 and 94 for further shipment transaction details.

The ability to receive emails summarizing the potential savings and actual savings can be useful to the shipping manager in that it allows the shipping manager to monitor shipping costs without to physically go to the computer through which the shipment was processed to retrieve shipping history. In addition, the ability to receive emails summarizing the potential savings and actual savings can also be useful to the individual (e.g., a sales person) who installed the second software application for processing shipment through USPS in that it allows the individual to track the usage of the second software application and gives the opportunity to remind the shipping manager at the organization that shipping through USPS would have saved the organization a certain dollar amount as indicated in the potential savings report log. This can be done remotely by the sales person by contacting the shipping manager (e.g., via email, telephone or text message) which saves time and travel costs to the sales person.

In some embodiments, application programs for performing methods in accordance with embodiments of the invention can be embodied as program products in a computer such as a personal computer or server or in a distributed computing environment comprising a plurality of computers. The computer may include, for example, a desktop computer, a laptop computer, a handheld computing device such as a PDA, etc. The computer program products may include a computer readable medium or storage medium or media having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card (e.g., a USB flash card), PCMCIA memory card, smart card, or other media. Alternatively, a portion or the whole computer program product can be downloaded from a remote computer or server via a network such as the internet, an ATM network, a wide area network (WAN) or a local area network.

Stored on one or more of the computer readable media, the program may include software for controlling both the hardware of a general purpose or specialized computer or processor. The software also enables the computer or processor to interact with a user via output devices such as a graphical user interface, head mounted display (HMD), etc. The software may also include, but is not limited to, device drivers, operating systems and user applications.

Alternatively, instead or in addition to implementing the methods described above as computer program product(s) (e.g., as software products) embodied in a computer, the method described above can be implemented as hardware in which for example an application specific integrated circuit (ASIC) can be designed to implement the method or methods of the present invention.

Although the various steps of the method(s) are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

In the above paragraphs, it is described that in one embodiment the second mail carrier is USPS. However, as it can be appreciated, the second mail carrier can be any other mail carrier.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed:

1. A method for comparing cost of shipping options, comprising:
determining, with a computer system, based on shipping data input into the computer system, a first shipping cost for shipping the package using a first mail carrier;
determining, with the computer system, based on the shipping data, a second shipping cost for shipping the package using a second mail carrier;
calculating, with the computer system, a cost difference between the first shipping cost and the second shipping cost;
outputting by the computer system the cost difference; and
periodically sending the cost difference for shipping the package or a plurality of packages to an individual or organization monitoring shipping costs.

2. The method according to claim 1, wherein the second shipping cost is less than or equal to the first shipping cost.

3. The method according to claim 1, further comprising summing the cost difference for the plurality of packages; and wherein the sending comprises sending the summed cost difference to the individual or organization.

4. The method according to claim 1, wherein input shipping data includes a destination address and a destination postal code.

5. The method according to claim 1, wherein input shipping data includes a weight of the package or dimensions of the package, or both.

6. The method according to claim 1, wherein determining the first shipping cost comprises accessing a shipping rate table of the first mail carrier.

7. The method according to claim 1, wherein determining the second shipping cost comprises accessing a shipping rate table of the second mail carrier.

8. The method according to claim 1, further comprising displaying the first shipping cost, the second shipping cost and the cost difference on a display of the computer system.

9. The method according to claim 1, further comprising storing in a memory of the computer system the first shipping cost, the second shipping cost and the cost difference.

10. The method according to claim 1, wherein the second mail carrier is the United States Postal Service (USPS) and the first mail carrier is any other mail carrier other than the USPS.

11. The method according to claim 10, wherein the first mail carrier is UPS, FedEx, or DHL.

12. The method according to claim 1, wherein outputting the cost difference comprises outputting the cost difference as actual cost savings if the package is shipped using the second mail carrier and outputting the cost difference as potential cost savings if the package is shipped using the first mail carrier.

13. The method according to claim 1, further comprising storing the cost difference as actual savings or as potential savings.

14. The method according to claim 1, further comprising:
outputting the cost difference for the plurality of packages shipped using either the first mail carrier or the second mail carrier;
storing the cost difference as actual savings in a first file for packages that are shipped using the second mail carrier;
storing the cost difference as potential savings in a second file for packages that are shipped using the first mail carrier; and
summing all actual savings to obtain a sum of actual savings and summing all potential savings to obtain a sum of potential savings of packages shipped during a desired time period.

15. The method according to claim 14, further comprising sending the first file and second file to the individual or organization monitoring shipping costs.

16. The method according to claim 15, wherein sending comprises emailing the first file and the second file.

17. A computer program product comprising a computer readable medium having instructions stored thereon when executed by the computer system performs the method recited in claim 1.

18. A system for comparing cost of shipping options, the system comprising a processor configured to:
determine, based on shipping data input by a user, a first shipping cost for shipping a package using a first mail carrier;
determine, based on the shipping data input by the user, a second shipping cost for shipping the package using a second mail carrier;
calculate a cost difference between the first shipping cost and the second shipping cost;
output the cost difference; and
send the cost difference for shipping to package or a plurality of packages to an individual or organization monitoring shipping costs.

19. The system according to claim 18, wherein the second shipping cost is less than or equal to the first shipping cost.

20. The system according to claim 18, further comprises an input device in communication with the processor, the input device configured to input shipping data including a destination address and a destination postal code, a weight of the package or dimensions of the package, or in combination of two or more thereof

21. The system according to claim 18, further comprising a display device in communication with the processor, the display device configured to display the first shipping cost, the second shipping cost and the cost difference.

22. The system according to claim 18, further comprising a memory in communication with the processor, the memory configured to store the first shipping cost, the second shipping cost and the cost difference.

23. The system according to claim 18, wherein the second mail carrier is the United States Postal Service (USPS) and the first mail carrier is any other mail carrier other than the USPS.

24. The system according to claim 23, wherein the first mail carrier is UPS, FedEx, or DHL.
